(19) United States
(12) Patent Application Publication
(10) Pub. No.: US 2003/0219468 A1
(43) Pub. Date: Nov. 27, 2003

(54) B-glucan-containing sorbic acid preparation as feed additive in farm animal rearing

(76) Inventors: Nico N. Raczek, Kelkheim (DE); Hans-Ulrich Ter Meer, Frankfurt (DE)

Correspondence Address: ProPat, L.L.C., 2912 Crosby Road, Charlotte, NC, 28211-2815, US

(21) Appl. No.: 10/436,556

(22) Filed: May 13, 2003

(30) Foreign Application Priority Data
May 21, 2002 (DE) 102 22 358.0

(51) Int. Cl. A23K 1/165; A23K 1/17

(52) U.S. Cl. 424/442; 426/635

(57) ABSTRACT

The present invention relates to a preparation for use in animal feed. The preparation comprises sorbic acid and at least one bioavailable β-glucan and also if appropriate a carrier and a further acid. In addition, the invention relates to the use of the preparation alone in feeds or in a mixture with other feed additives for improving the hygiene state of the feed and for growth promotion in farm animal rearing.

The invention relates to a preparation which comprises a high bioavailable β-glucan content and sorbic acid and can be used alone in feeds or in a mixture with other feed additives in farm animal rearing.

### BACKGROUND OF THE INVENTION

In the animal feeds sector, antibiotics are frequently used as growth promoters. The use of antibiotics in this sector is under suspicion as being responsible for hazards due to resistant bacteria which can also endanger human health in the long term. Therefore, products of less concern for health must be sought for this application. Thus, in other fields also, increasingly substances which are of concern physiologically and epidemiologically for health or are harmful for the environment, for example antibiotics, substances releasing formaldehyde, halogenated substances and many others, are being replaced by less hazardous substances, for example, in foods, feeds, pet food, silages, pomace or other wastes from the food industry. The purpose of these substances is firstly directed toward retaining the value of the actual product, but secondly, also, their sanitary condition is to be improved or prolonged shelf life is to be achieved.

It is known that sorbic acid can be used for preserving feeds. Sorbic acid (trans,trans-2,4-hexadienoic acid) is a colorless solid compound which is only slightly soluble in cold water and is used worldwide as a preservative. The principle of action is determined by sorbic acid in nondissociated form. Sorbic acid therefore develops the best activity in the acidic pH range. Sorbic acid and its salts have a very high microbiostatic antimycotic activity. At the same time, sorbic acid, as an unsaturated fatty acid, is virtually nontoxic, which is verified by highly extensive data and by the use of this acid for decades in the food sector, in animal feeds, inter alia.

In addition to sorbic acid, other organic acids have also been used for years for preserving feeds and for improving feed hygiene. Special requirements are made on the hygiene quality of the feed for young animals. Therefore, some organic acids are permitted as feed additives, on the basis of the national feed regulations, without maximum limiting values.

It is further known that yeast or yeast constituents can be added to feeds. Yeasts are high in vitamins and, in the protein fraction, have high contents of the amino acid lysine. Therefore, yeasts are an inexpensive and nutritional feed additive. The carbohydrate fraction largely consists of cell wall carbohydrates, which also include glucans which, in monogastric animals, cannot be broken down enzymatically until the large intestine.

U.S. Pat. No. 5,576,015 and EP-A-0 466 037 describe the use of purified β-(1,3)-glucan from the carbohydrate fraction of yeasts, inter alia, also for use in the nutrition of aquatic animals. U.S. Pat. No. 5,576,015 describes administering cell wall extracts consisting of β-1,3-glucan of certain particle sizes to various animal feeds. The purpose of this addition is growth promotion and a decrease in deaths during rearing of the animals.

WO 95/30022 describes the process for producing, and the use of, enzymatically treated glucans from yeast cells.

The immunological activity of glucans in the animal is widely known (Jan Raa, Beta-glucans, Petfood Industry, pp. 18+20-21, May 2000). Hertrampf, J. W., Alternative Antibacterial Performance Promoters, Poultry International, 40, 50-55, January 2001, also describes, inter alia, the use of various β-glucans as immune stimulator in poultry rearing.

In addition, the immunizing activity of β-(1,3) glucan from bacteria (Curdlan) in mice toward Plasmodium berghei is known (Kumar, P.; Ahmad, S.; Ann. Trop. Med. Parasitol. (1985), 79(2), 211-213, 1985).

It is also known that β-glucans from yeast have an immune-stimulating activity in mice toward Staphylococcus aureus (Di Luzio, N. R., Williams, D. L.; Infect. Immun. (1978), 20(3), 804-810). Thus lentinan, a glucan, for example from the mushroom Lentinus edodes or Cortinellus shiitake, is used in Asia as an antitumor agent. This also applies to schizophyllan, a β-glucan from, for example, Schizophyllium commune (Vetvicka, V., β-Glucans as Immunomodulators, Journal of the American Nutraceutical Association, Vol. 3, No. 4, pp. 31-34, Winter 2001). An immune-stimulating activity is also ascribed to the addition of laminaran-containing (β-(1,3) glucan) brown algae in Asian cuisine.

It is further known that piglet feeds made of oatflakes and casein lead to a greater weight gain than feed from corn and soya (Etheridge, R. D.; Seerley, R. W.; Wyatt, R. D., JOURNAL OF ANIMAL SCIENCE, Vol. 58, No. 6, 1984, 1396-1402). Oatflakes likewise contain β-glucans, but β-glucans from cereals are not bioavailable in the context of this invention as was found by Robertson et al. (Int. J. Biological Macromolecules; 21 (1997) 57-60). They must therefore be first mechanically, chemically or enzymatically disrupted. Suitable methods for this are milling processes, aqueous extraction in an alkaline medium or enzymatic treatment with, for example, carboxypeptidase.

U.S. Pat. No. 6,214,337 describes the use of β-glucans from yeasts to enhance animal performance. For this, between 0.001 and 10% by weight of a mannan-free (including phosphomannan and mannoprotein) glucan containing at least 40 to 99% β-(1,3)- and β-(1,6)-glucan is used. In the examples, feed mixtures treated with antibiotic mixtures are used. No comparison is shown with yeast-glucan-free or antibiotic-free feed. Also, the combination with organic acids is not described.

Overall, it has been disadvantageous in the case of such previously known β-glucan-containing feed additives or premixes that they are very microbiologically susceptible and relatively unstable. The growth-promoting effects achievable with them are therefore accompanied by considerable disadvantages in handling. Furthermore, the additions of yeast cell wall extracts, cereal extracts (in particular oat or barley extracts) and fungal extracts to feeds have the disadvantage that the growth promotion achieved thereby is only possible to a slight extent. This applies, in particular, when the product is subjected to relatively long storage times or must be stored temporarily in prepared form (in liquid or solid form) when used in agricultural operations. The β-glucan-containing cereals have the disadvantage that the β-glucan present in them is scarcely bioavailable. It was therefore an object to provide a growth-promoting additive which is simple to handle and does not have these disadvantages.

### BRIEF DESCRIPTIONS OF THE INVENTION

This object is achieved by a preparation (composition) which comprises sorbic acid and/or one of its salts and at least one bioavailable β-glucan. Preference is given to β-glucans from yeast cells, cereals (in particular oat extracts or barley extracts), fungi, lichens or algae. Particular preference is given to a preparation which comprises these said constituents applied to a carrier.

### DETAILED DESCRIPTION OF THE INVENTION

“Bioavailable” in the context of the invention is taken to mean the free β-glucan, that is to say not bound to cell walls, in particular in the alimentary tract of the animals. The β-glucans are considered to be bioavailable, in particular, when they are present at preferably 5-95% by weight (based on the preparations) in the above-described free form in the inventive preparations.

Glucans generally are taken to mean polyglucosans, that is to say mostly naturally occurring unbranched and branched polymers of glucose. These occur in particular in yeasts, cereals (in particular oat and barley cereals), fungi, lichens and algae. Preferably, β-glucans are used inventively, that is to say glucans in which the glucose units are β-(1,3)- and/or β-(1,4)-linked and may have 1,3 and/or 1,6 branches.

If the β-glucans are produced from yeasts, the yeasts preferably used are those of the strains Candida albicans, Candida cloaceae, Candida tropicalis, Candida utilis, Geotrichum candidum, Hansenula americana, Hansenula anomala, Hansenula wingei, Hansenula arni, Hansenula henricii, Hansenula canadiensis, Hansenula capsulate, Hansenulapolymorpha, Kloeckera brevis, Kloeckera apiculata, Kluyveromyces polysporus, Kluyveromyces bulgaricus, Kluyveromyces fragilis, Pichia fermentans, Pichia kluveri, Pichia pastoris, Pichia polymorpha, Pichia rhodanesis, Pichia ohmeri, Saccharomyces bisporus, Saccharomyces boulardii, Saccharomyces cerevisiae, Saccharomyces capsularis, Saccharomyces delbrueckii, Saccharomyces fermentati, Saccharomyces lugwigii, Saccharomyces microellipsoides, Saccharomyces pastorianus, Saccharomyces rosei, Saccharomyces rouxii, Saccharomyces synnaedendra, Schizosaccharomyces pombe, Torulopsis bovina, Torulopsis glabrata and in particular wine yeast and baker's yeast.

A number of possibilities exist for producing β-glucans from the yeast cells. In principle, the glucans, in particular β-glucans, are treated with alkaline earth metal hydroxides/alkali metal hydroxides at a low concentration of 0.05-1.0% stepwise or successively also with surfactant-containing (for example lauryl sulfonate-containing) solution at temperatures between 20 and 100° C. For this, numerous protocols are shown and examples given in U.S. Pat. No. 4,810,646, U.S. Pat. No. 5,082,936 and EP-A-0 466 037, which are expressly incorporated herein by reference. After extraction of the cell wall fractions, the residue is gently dried. Yeast cell walls suspended in water or suitably diluted extraction solution, which have a high content of bioavailable β-glucans, can also be produced in this manner. Furthermore, glucans can be produced from yeasts by a combination of mechanical disintegration, purification and freeze-drying and subsequent enzymatic disruption, with subsequent centrifugation (as described in DE-A-198 35 767, which is expressly incorporated herein by reference).

In the case of a dry product from yeast cell walls, expediently, the dry matter content of the resultant residue should be greater than 90% by weight and the polysaccharide content should be at least 70% by weight (in each case based on the yeast cell wall extract). The bioavailable glucan content in the polysaccharide fraction should expediently be at least 75% by weight. In the case of liquid cell walls or liquid preparations, equivalent contents based on the dry matter are calculated.

Oat extracts or barley extracts in the context of this invention are fractions produced by milling from the cereal species of oaks (genus: Avena) or barley (genus: Hordeum) which comprise β-glucans typical of these cereal species. Furthermore, these are taken to mean extracts from these cereals which have been produced from these cereals by treatment with suitable solvents and comprise β-glucans. The extracts can be used either in dissolved form or as powder/granules/agglomerates. Various possibilities exist for producing β-glucans from cereals. Some are described in WO 2001/026479, which is expressly incorporated herein by reference. They can be separated into fractions, for example by grinding processes, (for example into the bran fraction, which typically comprises between 7 and 20% by weight of bioavailable β-glucan).

A further enrichment in β-glucan content is possible by extraction of the brans, as described, for example, in U.S. Pat. No. 5,518,710, which is expressly incorporated herein by reference. By this means, typically bioavailable β-glucan contents of 30 to 95% by weight may be obtained. In addition, β-glucan-containing fractions in the context of this invention are taken to mean barley extracts and oat extracts which, inter alia, can be produced from the abovementioned products.

Other isolates containing bioavailable β-glucans from fungi such as linghi (Ganoderma lucidum) or shiitake mushroom (Lentinus edodes) or Cortinellus shiitake or a similar species (described, for example, in “Functional Properties of Edible Mushrooms”; Mattila-P, Suonpää-K, Piironen-V; Nutrition; 16 (7/8) 694-696, 2000) or extracts from lichens (scleroglucan from lichens, sclerotium species, described, for example, in “Isolation and physicochemical characterization of soluble scleroglucan from Sclerotium rolfsii”; Fariña-JI, Siñeriz-F, Molina-OE, Perotti-NI; Carbohydrate Polymers 44 (2001) 41-50), for example the commercial product Polytran® (Pillsburg Co., Delaware 1343, Minneapolis, Minn. 55402; β-1,3-linked D-glucose, to which D-glucose is linked as side chain via β-1,6-bonds) are also a material having bioavailable β-glucans in the context of this invention and can be used as an alternative to abovementioned extracts from yeast cell walls or cereals. This also applies to laminaria-containing extracts from brown algae (laminaria species) which comprise bioavailable β-(1,3) glucans, occasionally also containing β-(1,6) glycosidic bonds.

The percentages by weight specified below are based on the total mass of the preparation.

Bioavailable β-glucans are present in the inventive preparations in amounts of from 5 to 95% by weight, preferably 15 to 80% by weight, in particular 50 to 75% by weight.

In addition to β-glucans, the inventive preparation comprises sorbic acid and/or a salt of sorbic acid. Suitable salts of sorbic acid are, in particular, the potassium, sodium, calcium and magnesium salts.

In addition to sorbic acid and/or its salts, in addition, further inorganic and/or organic solid and/or liquid acids and/or their salts can also be used in the inventive preparation.

The organic acids which can be used according to the invention include, for example, formic, acetic, propionic, butyric, valeric, isobutyric, trimethylacetic, isovaleric, 2-methylbutyric, hexanoic, succinic, adipic, fumaric, malic, tartaric, citric, lactic, ascorbic, glucanoic and amino acids, in particular essential amino acids and salts thereof, but also inorganic acids such as phosphoric, hydrochloric or sulfuric acid and salts thereof.

The inventive preparation comprises from 95 to 5% by weight, preferably 85 to 20% by weight, and very particularly preferably 50 to 25% by weight, sorbic acid and/or salts thereof. If, in addition to sorbic acid and/or salts thereof, one or more other inorganic and/or organic solid and/or liquid acid(s) or salts thereof is used, the quantitative data relates to the total content of acids. Sorbic acid should here make up 50% by weight of the acid fraction.

The β-glucans and/or acids or salts can also be applied to carriers. Carriers which can be used are organic and/or inorganic materials having a porous structure. These include, for example, natural absorbent materials such as rice flour, beet cossettes, palm kernel extraction meal, corn flour, cereal bran, soyabean extraction meal, feather meal, fish meal, bone meal or suitable wastes from the food industry; in addition synthetic or natural amorphous precipitated silicas, perlite (E 599), another sodium aluminum silicate, diatomaceous earth, clay, sand, nylon powder, insoluble metal oxides, insoluble metal salts, aerosil, corundum, ground glass, granite, quartz, flint, aluminum phosphate, kaolin, bentonite, zeolites, calcium silicate, talc, titanium oxides, activated carbon, magnesium silicate or mixtures thereof.

Where present, the carriers are used in amounts of >0-20% by weight (based on the preparation). The carriers used can be the abovementioned substances alone or in combination. The use of carriers when liquid acids are used has proved particularly advantageous.

The inventive preparation can be produced as follows: sorbic acid and if appropriate one or more other solid and/or liquid acids or salts thereof and the β-glucan, for example in the form of a β-glucan extract, are mixed mechanically. If the inventive preparation comprises a carrier, any liquid acid(s) present are first applied to the carrier expediently in a commercially conventional tumbling mixer or other customary mixer and then the sorbic acid, any other solid acid(s) present and finally the β-glucan, for example in the form of an extract, are added.

The inventive preparations can then be incorporated into animal feeds.

Suitable animal feeds are, for example, green fodder, silages, dried green fodder, roots, tubers, pulpy fruits, grains and seeds, brewer's spent grains, pomace, brewer's yeast, spent distiller's grains, milling byproducts, byproducts of sugar and starch production and oil production and various food wastes. Those which are particularly suitable are cereals such as barley or wheat. Such feeds can be admixed with certain feed additives (for example antioxidants) or mixtures of various substances (for example mineral mixes, vitamin mixes) for improvement. Special feeds are also adapted for certain animal species and their stages of development. This is the case, for example, in piglet rearing. Here, piglet prestarter feed and piglet starter feed are used.

The inventive preparation can be added directly to the animal feed or else in a mixture with other feed additives or else be added via premixes to the actual feed. The preparation can be added dry to the feed, can be added before further processing (e.g. extrusion) or added dispersed in the mixture. For these purposes, expediently, preparation concentrations between 0.5 and 12.5% by weight, preferably 1.0 to 10.0% by weight, based on the feed, are used. Furthermore, the individual constituents of the preparation can be added separately to individual constituents of the feed. Such separate combinations can be provided, for example, as a kit.

The preparation can be added as sole additive to animal feeds, for example for calf/lamb raising or poultry rearing, particularly preferably to piglet prestarter and piglet starter feeds, or used in a mixture with other feed additives for these animals.

Surprisingly, it has been found that even by adding small amounts of inventive preparations in piglet rearing, a marked performance improvement can be achieved with respect to growth rate and feed utilization. To secure a significant nutritive effect, an addition of inventive preparations in amounts of 0.5 to 12.5% by weight, preferably from 1.0 to 10.0% by weight, based on the feed, is expedient. In addition, feeds containing the inventive preparation are suitable as milk replacers in early weaning of weaning lambs or calves and in chick growing feed.

Furthermore, surprisingly, a beneficial effect on growth performance of young animals can be found, even when relatively small amounts of inventive preparations are added.

Surprisingly, the inventive preparations do not exhibit the disadvantages described above for the prior art. The preparations, rather, exhibit good properties in handling. The products are free from molds or other microorganisms both during storage as (pre)dissolved additive or as dry premix, for example in silos or other storage apparatuses over a long period. In addition, a stable mixture is achieved which exhibits good properties and does not stick together. This also relates to the use of liquid acids.

By adding preparations, in addition, effective acidification of the feed is achieved.

Furthermore, the inventive β-glucan-containing products lead to a higher softness of the feed. As a result of this tactile attraction, the mixture is preferred by the animals.

In addition, surprisingly, better utilization of the nitrogen supply in the diet was found in the presence of the β-glucan-containing inventive preparations containing oat and barley extracts, which decreased the frequency of diarrhea.

Furthermore, the inventive preparation is able to improve the hygiene state by desired microorganisms encountering favorable development conditions from the start, while unwanted organisms and pathogens which otherwise can consume nutrients present, are suppressed.

Furthermore, the present studies show a synergistic action of β-glucans and organic acids, in particular the combination of β-glucan-containing oat extracts (Oat Bran Concentrate OBC, Ceapro, Edmonton, Canada) with sorbic acid.

The invention is described below with reference to examples.

To study the performance-enhancing activity of the inventive preparations, feeding experiments were carried out each using 48 weaning piglets, individually held. The feed of the four experimental groups was of isoenergetic composition and was presented to the animals for ad lib intake.

A preparation of β-glucan concentrate [15% by weight β-glucan, remainder: starch, proteins and insoluble fiber (Ceapro, Edmonton, Canada)] and sorbic acid (Nutrinova GmbH, Frankfurt) was prepared (the concentration of bioavailable β-glucan was then at least 12-15%). In this case 1 kg of the β-glucan concentrate was mixed thoroughly with 0.5 kg of sorbic acid. 300 g of such a mixture were added in each case to 10 kg of a piglet feed.

If such a preparation is added to piglet feed, no change in feed intake behavior of the animals can be observed. The preparation is in addition readily handleable and easy to add to the piglet prestarter or piglet starter feed.

This addition to the feed, even at the very low concentrations, showed a significant dose-effect relationship in the piglets, based on the growth, and exhibited increased growth rates.

1. A preparation comprising at least one bioavailable β-glucan and at least one of sorbic acid and a salt of sorbic acid.

2. The preparation as claimed in claim 1, wherein the bioavailable β-glucan is produced from yeast cells, cereals, fungi, lichens or algae.

3. The preparation as claimed in claim 1, wherein it comprises about 5 to about 95% by weight (based on the preparation) of bioavailable β-glucan.

4. The preparation as claimed in claim 1, wherein it additionally comprises a carrier.

5. The preparation as claimed in claim 1, wherein the preparation comprises at least about 5% by weight of sorbic acid.

6. The preparation as claimed in claim 1, wherein it comprises about 10-50% by weight of sorbic acid (based on the preparation).

7. The preparation as claimed in claim 1, wherein it additionally comprises one or more acid or acids different from sorbic acid or a salt or salts thereof.

8. The preparation as claimed in claim 7, wherein the acid different from sorbic acid or a salt thereof is selected from the group consisting of: formic, acetic, propionic, butyric, valeric, isobutyric, trimethylacetic, isovaleric, 2-methylbutyric, hexanoic, succinic, adipic, fumaric, malic, tartaric, citric, lactic, ascorbic, glucanoic, amino, phosphoric, hydrochloric, sulfuric acid and salts thereof.

9. The preparation as claimed in claim 7, wherein the acid or acids different from sorbic acid or a salt or salts thereof is or are present in the preparation in amounts of >0 to about 40% by weight (based on the preparation).

10. A feed which comprises a preparation as claimed in claim 1.

11. A feed additive which comprises a preparation as claimed in claim 1.

12. The feed as claimed in claim 10, wherein it comprises about 0.5-12.5% by weight (based on the feed) of the preparation.

13. A method of making an animal feed or feed additive which method comprises converting a preparation as claimed in claim 1 into an animal feed additive or feed additive.

14. The method as claimed in claim 13 for pig growing and finishing.

15. The method as claimed in claim 13 for rearing of breeding sows.

16. The method as claimed in claim 13 for beef growing and finishing.

17. The method as claimed in claim 13 for lamb growing and finishing.

18. The method as claimed in claim 13 for sheep breeding and finishing.

19. The method as claimed in claim 13 for fish rearing and edible fish husbandry.

20. The method as claimed in claim 13 for the rearing and husbandry of crustaceae.

21. The method as claimed in claim 13 for poultry rearing.

22. The method as claimed in claim 21 for the rearing of chicks.

23. The method as claimed in claim 21 for the rearing of laying hens.

24. The method as claimed in claim 21 for the rearing and finishing of turkeys and geese.

25. The method as claimed in claim 13 for the rearing and husbandry of domestic animals.

26. The use method as claimed in claim 25 for the rearing and husbandry of dogs, cats, birds, aquarium fish and small rodents.
